(19) United States
(12) Patent Application Publication
(10) Pub. No.: US 2018/0357162 A1
(43) Pub. Date: Dec. 13, 2018

(54) METHOD AND SYSTEM FOR PROVIDING REAL-TIME UNIFIED VIEWING ACCESS TO USERS FOR MONITORING COLLATERAL ALLOCATION

(71) Applicant: WIPRO LIMITED, BANGALORE (IN)

(72) Inventors: Abhinav KHANDKA, Bangalore (IN); Amrit RAJGURU, Bangalore (IN)

(73) Assignee: Wipro Limited

(21) Appl. No.: 15/667,681

(22) Filed: Aug. 3, 2017

(30) Foreign Application Priority Data
Jun. 12, 2017 (IN) 201741020488

(51) Int. Cl. G06F 12/02

(52) U.S. Cl. CPC G06F 12/0284

(57) ABSTRACT

Disclosed herein is method and system for providing real-time unified access to users for monitoring collateral allocation. Allocation information related to allocation of collaterals between a provider and receiver of the collaterals are collected. Also, allocation rules determined by bilaterally agreed collateral terms related to the collaterals allocation and real-time data are retrieved from a reference database. The collected information is validated by comparing them with regulatory rules for allocating the collaterals to the receiver from the provider. Finally, the real-time unified view of the collaterals allocation is provided to the users, thereby establishing a real-time monitoring of the collateral allocation. The present disclosure ensures complete compliance of collateral allocation with the regulatory rules and regulations through real-time checks that are digitally verified. Further, the method helps in enhancing transparency in collateral allocation and management processes, thereby mitigating complexities arising out of segregation of collateral assets.

### TECHNICAL FIELD

The present subject matter is related, in general to collateral management and more particularly, but not exclusively to a method and system for providing real-time viewing access to users for monitoring collateral allocation.

### BACKGROUND

Due to lack of in-house resources and complex nature of collateral management, many institutions engage efficient third-party collateral management entities for managing collaterals. When making such decisions, the institutions must ensure that selected collateral management entities can support management of collaterals globally with sophisticated solutions that help to optimize use of collaterals and manage movements with efficiency.

Currently, the collateral management entities involve performing matching of required values of collaterals and developing an allocation pattern for the required values of collaterals. Then, collateral allocation developed by the collateral management entities are checked against regulatory rules for validating the collateral allocation. However, due to lack of real-time view of the collateral asset allocations done by the collateral management entities, the institutions suffer from various operational bottlenecks, for example inefficient collateral optimization, regulatory risks, credit risk and collateral liquidity risks, and the like.

Also, the collateral asset allocations made by the collateral management entities must be periodically checked for compliance to regulations set by collateral allocation regulatory bodies. Obligation of compliance to such regulations lies with the institutions and not with the collateral management entities. Thus, the institutions carry risks of being penalized by the regulatory bodies for non-compliance. Further, infrastructure and operational resources spent on maintenance of compliance checking platforms, which are used to monitor compliance of the collateral asset allocation with the regulations, involve money and are redundant.

### SUMMARY

Disclosed herein is a method of providing real-time unified viewing access to plurality of users for monitoring collateral asset allocation. The method comprises receiving, by a collateral allocation system, allocation information related to allocation of one or more collateral assets between a provider and a receiver from a manager tri-party agent of the one or more collateral assets. Thereafter, allocation rules determined by bilaterally agreed collateral terms and real-time data related to the provider and the receiver are retrieved from a reference database associated with the collateral allocation system. Further, the allocation of the one or more collateral assets is validated by comparing the allocation information, the allocation rules determined by bilaterally agreed collateral terms, and the real-time data with regulatory rules. Upon validating the allocation, the one or more collateral assets are allocated to the receiver from the provider based on the validation. Finally, real-time unified view of the one or more collateral assets allocated is provided to each of the plurality of users.

Further, the present disclosure relates to a collateral allocation system for providing real-time unified viewing access to the plurality of users for monitoring collateral asset allocation. The collateral allocation system comprises a processor and a memory. The memory is communicatively coupled to the processor and stores processor-executable instructions, which, on execution, causes the processor to receive allocation information related to allocation of one or more collateral assets between a provider and a receiver from a manager tri-party agent of the one or more collateral assets. Then, the instructions cause the processor to retrieve allocation rules determined by bilaterally agreed collateral terms and real-time data related to the provider and the receiver from a reference database associated with the collateral allocation system. Further, the processor validates the allocation of the one or more collateral assets by comparing the allocation information, the allocation rules determined by bilaterally agreed collateral terms, and the real-time data with regulatory rules. Furthermore, the processor allocates the one or more collateral assets to the receiver from the provider based on the validation. Finally, the processor provides a real-time unified view of the one or more collateral assets allocated to the plurality of users involved in the monitoring of collateral asset allocation.

Furthermore, the present disclosure relates to a non-transitory computer readable medium including instructions stored thereon that when processed by a collateral allocation system, performs operations comprising receiving allocation information related to allocation of one or more collateral assets between a provider and a receiver, from a manager tri-party agent of the one or more collateral assets. Then, the instruction cause the collateral allocation system to retrieve allocation rules determined by bilaterally agreed collateral terms and real-time data related to the provider and the receiver from a reference database associated with the collateral allocation system. Further, the collateral allocation system validates the allocation of the one or more collateral assets by comparing the allocation information, the allocation rules determined by bilaterally agreed collateral terms, and the real-time data with regulatory rules. Furthermore, the collateral allocation system allocates the one or more collateral assets to the receiver from the provider based on the validation. Finally, the collateral allocation system provides a real-time unified view of the one or more collateral assets allocated to each of the plurality of users.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for providing a real-time unified viewing access to plurality of users for monitoring collateral asset allocation in accordance with some embodiments of the present disclosure;

FIG. 2 shows a detailed block diagram illustrating a collateral allocation system for providing real-time unified viewing access to the plurality of users in accordance with some embodiments of the present disclosure;

FIG. 3 shows a flowchart illustrating a method for providing a real-time unified viewing access to the plurality of users in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a collateral allocation system for providing real-time unified viewing access to plurality of users for monitoring collateral asset allocation. The proposed system and method provide a real-time view of the one or more collateral assets that are allocated by a manager tri-party agent, from a collateral provider to a collateral receiver. As an example, the one or more collateral assets that are allocated to the receiver may include collaterals in the form of pre-owned properties, pre-owned market shares or any tangible/intangible collateral that belongs to the provider. In an embodiment, the manager tri-party agent may be an individual or an institution that functions as a third-party agent between the provider and the receiver during setting up of initial allocation of the one or more collateral assets from the provider to the receiver.

In an embodiment, the instant disclosure discloses using a blockchain technique for ensuring compliance of the allocation of the one or more collateral assets with regulatory rules that govern the collateral asset allocation process. The application of blockchain technique helps in shared recordkeeping and reporting of allocation data related to the collateral asset allocation process makes the allocation data immutable. Moreover, the blockchain technique performs regulatory checks that are digitally verified with the regulatory rules and ensures 100% compliance to the regulatory rules. In an embodiment, the regulatory rules are the predetermined set of rules provided by one or more regulators of the collateral asset allocation process. As an example, the regulatory rules may include rules for carrying out the collateral asset allocation process, which are formulated and standardized by the collateral allocation regulators.

In an embodiment, since each user participating in the collateral asset allocation process is provided with a real-time access to view the one or more collateral assets being allocated between the provider and the receiver, the envisioned method and the system enhances transparency of the collateral asset allocation to effectively eliminate risk evolving out of the collateral asset allocation process. Further, the proposed method creates a consensus among all the participating users to make the process democratic and solution strategic and thereby achieving a high degree of collateral management through access to the immutable copy of the reference data.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

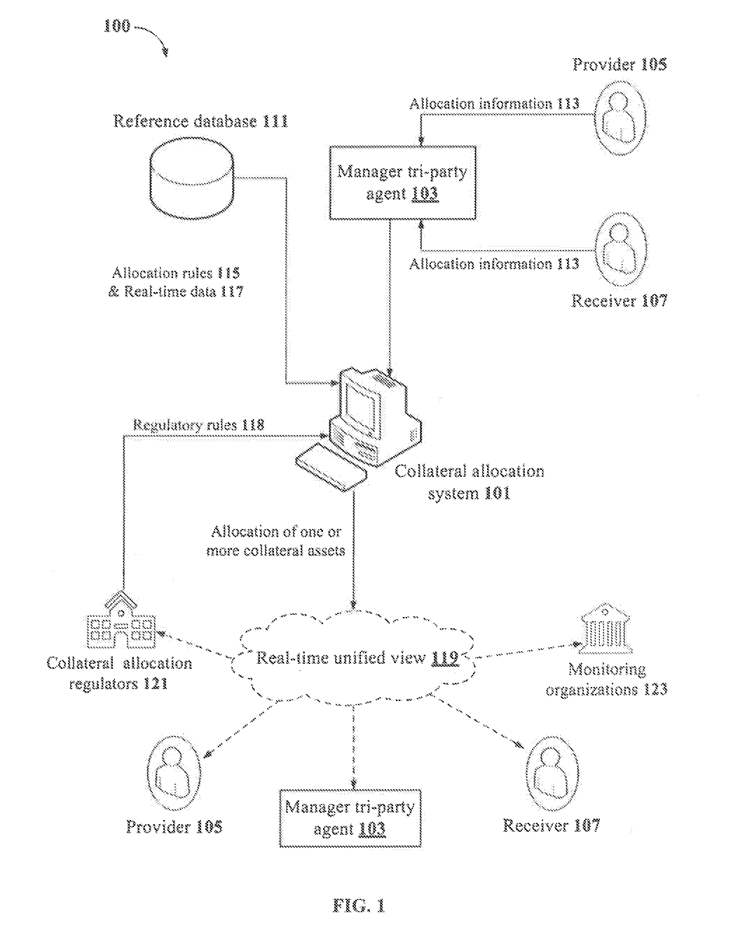

FIG. 1 shows an exemplary environment for providing a real-time unified viewing access to the plurality of users for monitoring collateral asset allocation in accordance with some embodiments of the present disclosure.

The environment 100 includes a collateral allocation system 101, which is communicatively connected to a manager tri-party agent 103 and a reference database 111. The manager tri-party agent 103 functions as a third-party agent/entity between a provider 105 and a receiver 107 of one or more collateral assets. The manager tri-party agent 103 communicates with the provider 105 and the receiver 107 for receiving allocation information 113 related to the allocation of the one or more collateral assets. As an example, the allocation information 113 may include a Required Value (RQV) of the one or more collateral assets, an initial marginal value of the one or more collateral assets and agreed marginal values of the one or more collateral assets to be allocated from the provider 105 to the receiver 107.

In an embodiment, the reference database 111 may store allocation rules 115 determined by bilaterally agreed collateral terms related to the allocation of the one or more collateral assets between the provider 105 and the receiver 107. The allocation rules 115 determined by bilaterally agreed collateral terms are provider-receiver specific rules that are mutually agreed between the provider 105 and the receiver 107. As an example, an allocation rule between the provider 105 and the receiver 107 may be that the provider 105 may be provided with a discount of 10% on each allocation made to the receiver 107. The allocation rules 115 determined by bilaterally agreed collateral terms may be periodically updated to include any modifications in the mutual agreement between the provider 105 and the receiver 107.

Further, the reference database 111 may also store real-time data 117 related to the one or more collateral assets of the provider 105 that are to be allocated to the receiver 107. As an example, the real-time data 117 may include current market value of the one or more collateral assets owned by the provider 105.

In an embodiment, upon receiving the allocation information 113, the allocation rules 115 determined by bilaterally agreed collateral terms and the real-time data 117, the collateral allocation system 101 validates the allocation of the one or more collateral assets. The validation is performed by comparing the allocation information 113, the allocation rules 115 determined by bilaterally agreed collateral terms, and the real-time data 117 with regulatory rules 118. The regulatory rules 118 are predetermined set of rules provided by one or more regulators 121 of the collateral asset allocation process. As an example, the regulatory rules 118 may include, without limiting to, at least one of rules for checking eligibility of the provider 105 and the receiver 107, rules for checking wrong way risks, concentration limits, credit quality steps, and difference between market values of the one or more collateral assets and a predefined collateral value.

In an embodiment, based on the validation, the collateral allocation system 101 determines whether the allocation of the one or more collateral assets between the provider 105 and receiver 107 are compliant with the regulatory rules 118. In an embodiment, the process of validating and allocating the one or more collateral assets to the receiver 107 from the provider 105 are implemented on a collateral allocation blockchain platform. The blockchain is a decentralized and distributed digital ledger that records allocation of collaterals across various participants, including the provider 105 and the receiver 107, in such a way that the registered collateral asset allocations cannot be altered by any of the plurality of users.

If the allocation of the one or more collateral assets is valid/compliant, then the collateral allocation system 101 generates a real-time unified view 119 of the one or more collateral assets allocated. In an exemplary embodiment, the real-time unified view 119 of the one or more collateral assets, allocated to the receiver 107, may be a universal representation of the collateral asset allocation, which may be accessed by the plurality of users participating in the collateral asset allocation. The plurality of users may include the provider 105, the receiver 107, the manager tri-party agent 103, the one or more collateral allocation regulators 121 and monitoring organizations 123. The one or more collateral allocation regulators 121 and the monitoring organizations 123 may be responsible for formulating and administering the regulatory rules 118.

As an example, the real-time unified view 119 may indicate various information like number of collaterals allocated, net value/worth of the allocated collaterals and details of the one or more collateral assets remaining with the provider 105 in view of the real-time data 117 retrieved from the reference database 111. Further, the collateral allocation system 101 may provide the real-time unified view 119 to each of the plurality of users through one or more user devices associated with the plurality of users. The plurality of users may view the real-time unified view 119 of the collateral asset allocation, thereby obtaining real-time information about the collateral asset allocation.

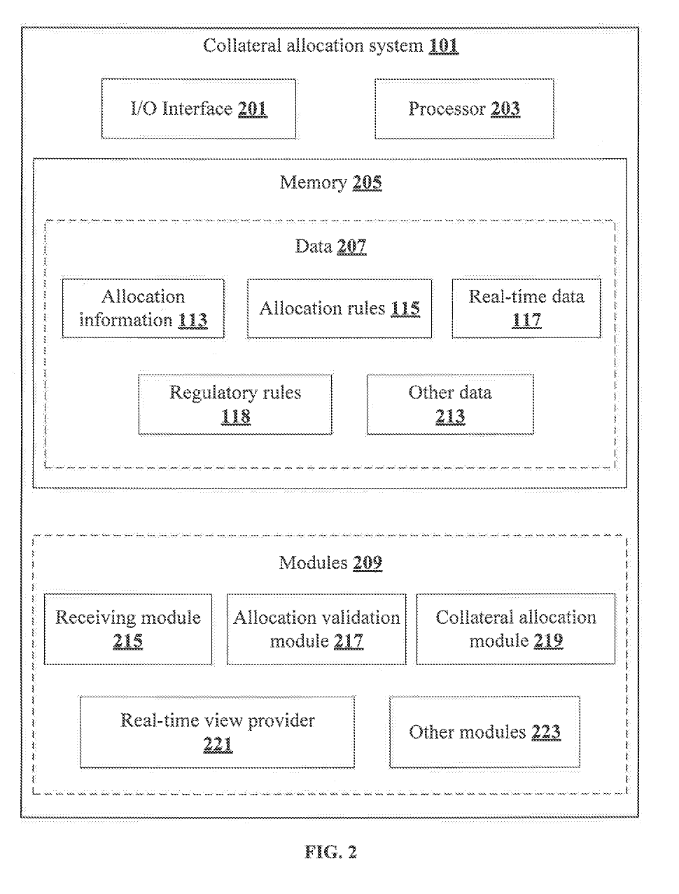

FIG. 2 shows a detailed block diagram illustrating a collateral allocation system 101 for providing real-time unified viewing access to the plurality of users in accordance with some embodiments of the present disclosure.

The collateral allocation system 101 includes an I/O interface 201, a processor 203, and a memory 205. The I/O interface 201 may be configured to receive allocation information 113 from the provider 105 and the receiver 107 through the manager tri-party agent 103. Further, the I/O interface 201 may be configured to retrieve allocation rules 115 determined by bilaterally agreed collateral terms and the real-time data 117 related to the provider 105 and the receiver 107 from reference database 111 associated with the collateral allocation system 101. The memory 205 may be communicatively coupled to the processor 203. The processor 203 may be configured to perform one or more functions of the collateral allocation system 101 for providing a real-time unified viewing access to the plurality of users for monitoring the allocation of the one or more collateral assets. In one implementation, the collateral allocation system 101 may include data 207 and modules 209 for performing various operations in accordance with the embodiments of the present disclosure. In an embodiment, the data 207 may be stored within the memory 205 and may include, without limiting to, the allocation information 113, the allocation rules 115 determined by bilaterally agreed collateral terms, the real-time data 117, regulatory rules 118 and other data 213.

In some embodiments, the data 207 may be stored within the memory 205 in the form of various data structures. Additionally, the data 207 may be organized using data models, such as relational or hierarchical data models. The other data 213 may store data, including temporary data and temporary files, generated by the modules 209 for performing the various functions of the collateral allocation system 101.

In an embodiment, the allocation information 113 may include information related to the one or more collateral assets and the allocation of the one or more collateral assets between the provider 105 and the receiver 107. As an example, the allocation information 113 may include, without limiting to, a Required Value (RQV) of the one or more collateral assets, an initial marginal value of the one or more collateral assets and agreed marginal values of the one or more collateral assets to be allocated from the provider 105 to the receiver 107.

In an embodiment, the allocation rules 115 determined by bilaterally agreed collateral terms may include any agreement made between the provider 105 and the receiver 107 during the allocation of the one or more collateral assets. Generally, the allocation rules 115 determined by bilaterally agreed collateral terms are specific to the provider-receiver pair. In some scenarios, the allocation rules 115 determined by bilaterally agreed collateral terms may be modified for each allocation, depending on the nature of allocation and type of the one or more collateral assets being allocated. For considering an allocation of the one or more collateral assets from the provider 105 to the receiver 107, it may be mandatory to ensure that the allocation rules 115 determined by bilaterally agreed collateral terms agreed between the provider 105 and the receiver 107 are compliant with the regulatory rules 118.

In an embodiment, the real-time data 117 related to the provider 105 and the receiver 107 may include various information related to financial status of the provider 105, the receiver 107, and economic status of the one or more collateral assets to be allocated. As an example, the real-time data 117 may include updated information from a ledger of accounts of the provider 105 and the receiver 107. Consideration of the real-time data 117 during the allocation of the one or more collateral assets may be helpful to establish a risk-free collateral asset allocation, since the real-time data 117 indicates current status of the provider 105 and the one or more collateral assets of the provider 105.

In an embodiment, the regulatory rules 118 are the predetermined set of rules provided by the one or more collateral allocation regulators 121, for example banking institutions, regulatory benches affiliated to states/central governments and the like. In an embodiment, the collateral asset allocation process would be considered as valid only when the collateral asset allocation process is compliant with regulatory rules 118. The regulatory rules 118 may include, without limiting to, at least one of rules for checking eligibility of the provider 105 and the receiver 107, rules for checking wrong way risks, concentration limits, credit quality steps, and difference between market values of the one or more collateral assets and a predefined collateral value. In an embodiment, the credit quality steps help in defining standardized scale of determining the credit quality of the one or more collateral assets being allocated during the collateral asset allocation process. The wrong way risks occur when the exposure to a counterparty is adversely proportional to the creditworthiness of the counterparty. In other words, the wrong way risks occur when a default risk and exposure to the counterparty increase together. Further, the concentration limits define a limit to weight of the one or more collateral assets among total collaterals allocated by the provider 105. This reduces the risk associated with offering diversification in the one or more collateral assets being allocated. Further, as an example, one of the regulatory rules 118 may be that, a provider 105, who is a citizen of India, cannot allocate any collateral to a receiver 107, if the receiver 107 is not a citizen of India.

In some embodiments, the data 207 may be processed by one or more modules 209 of the collateral allocation system 101. In one implementation, the one or more modules 209 may be stored as a part of the processor 203. In another implementation, the one or more modules 209 may be communicatively coupled to the processor 203 for performing one or more functions of the collateral allocation system 101. The modules 209 may include, without limiting to, a receiving module 215, an allocation validation module 217, a collateral allocation module 219, a real-time view provider 221 and other modules 223.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 223 may be used to perform various miscellaneous functionalities of the data visualization system 101. It will be appreciated that such modules 209 may be represented as a single module or a combination of different modules.

In some embodiments, the receiving module 215 may be responsible for receiving the allocation information 113 related allocation of the one or more collateral assets between the provider 105 and the receiver 107 through the manager tri-party agent 103. Further, the receiving module 215 may be responsible for retrieving the allocation rules 115 determined by bilaterally agreed collateral terms and the real-time data 117 related to the provider 105 and the receiver 107 from the reference database 111. In some implementations, the reference database 111 may be a part of the memory 205 of the collateral allocation system 101. Alternatively, the reference database 111 may be configured external to the collateral allocation system 101 and may be communicatively linked to the collateral allocation system 101 through a wired and/or a wireless communication network.

In an embodiment, the allocation validation module 217 may be responsible for checking compliance of the allocation of the one or more collateral assets between the provider 105 and the receiver 107 with the regulatory rules 118. The allocation validation module 217 may compare the allocation information 113, the allocation rules 115 determined by bilaterally agreed collateral terms, and the real-time data 117 with the regulatory rules 118 to determine whether the allocation process is compliant with allocation rules established by the one or more collateral allocation regulators 121. The allocation of the one or more collateral assets is considered as valid only when the allocation information 113, the allocation rules 115 determined by bilaterally agreed collateral terms and the real-time data 117 are compliant to the regulatory rules 118.

In an embodiment, the collateral allocation module 219 may be responsible for allocating the one or more collateral assets of the provider 105 to the receiver 107 upon determining that the allocation proposed by the manager tri-party agent 103 are valid. Further, upon allocating the one or more collateral assets, the collateral allocation module 219 keeps a track of each of the one or more collateral assets allocated to the receiver 107. The track of allocated collaterals may be used as a reference for detecting any modifications in values of the one or more collateral assets.

In an embodiment, the real-time view provider 221 may be responsible for providing the real-time unified view 119 of the one or more collateral assets allocated to each of the plurality of users. The real-time unified view 119, as the name suggests, is a dynamic representation of the plurality of collaterals that are allocated from the provider 105 to the receiver 107. The real-time unified view 119 may be an immutable representation, which can be accessed and viewed by each of the plurality of users but cannot be modified by any of the plurality of users. Thus, the real-time unified view 119 enhances transparency in the collateral asset allocation process since each of the plurality of users can access/view information related to the collateral asset allocation process.

In some exemplary embodiments, the real-time unified view 119 may be provided in the form of graphs, lists, analysis charts or the like representations, thereby improving the ease with which each of the plurality of users can access/view and understand or analyze the collateral asset allocation process in real time. In some implementations, the real-time view provider 221 may be responsible for transmitting the real-time unified view 119 to one or more devices and/or display interfaces that are associated with the plurality of users.

As an exemplary embodiment of the instant disclosure, the collateral allocation system 101 may be used for effectively managing allocation of collaterals between the provider 105 of the collateral and the receiver 107 of the collateral through the manager tri-party agent 103. For example, at the beginning of a transaction between the provider 105 and the receiver 107, a segregated account record of both the provider 105 and the receiver 107 may be reset and fresh collateral asset allocations may be carried out based on Long Box (account ledger) positions of the providers (pledgers) of the collateral.

Further, the collateral allocation system 101 may validate an allocation logic from the Long Box with segregated account details of the provider 105 and the receiver 107 against two sets of rules—the allocation rules 115 determined by bilaterally agreed collateral terms between the provider 105 and the receiver 107 and the regulatory rules 118 set by the one or more allocation regulators 121. During allocation of collateral, the regulatory rules 118 may include performing checks such as, eligibility check, wrong way risk check, and concentration limit of the collateral. Similarly, the allocation rules 115 determined by bilaterally agreed collateral terms may include regulations against a Credit Support Annex (CSA) terms and provider-receiver specific agreements/conditions, which are validated against the regulatory rules 118. In some embodiments, the allocation rules 115 determined by bilaterally agreed collateral terms, which would need privacy, may be developed as services off the allocation process.

In another exemplary embodiment, the collateral asset allocation method of the instant disclosure may be used in a pharmaceutical supply chain system in which a provider 105 (such as a manufacturer of medicines) of a specific medicine can supply medicines to a receiver 107 (such as hospitals and medical stores) using the collateral allocation system 101. Initially, the provider 105 may communicate with one or more intermediate supply agents (manager tri-party agents 103), who, in turn, directly contact the one or more receivers 107 in the supply chain, for collecting information related to demand/requirement for the medicines at the one or more receivers 107. Based on the collected information, the provider 105 may supply the required units of medicines to the one or more receivers 107 through the intermediate supply agents.

In the meantime, the real-time unified view 119 of the complete supply process may be generated to indicate information related the supply of medicines from the provider 105 to the one or more receivers 107. As an example, the information indicated in the real-time unified view 119 may include names of the provider 105 and the one or more receivers 107, number of medicine units being supplied and information about selling price, discounts, profits, and the like. Further, the real-time unified view 119 may be accessed by one or more regulators and/or standard health organizations who are responsible for monitoring the pharmaceutical supply chains, thereby dynamically validating the supply of medicines from the provider 105 to the one or more receivers 107.

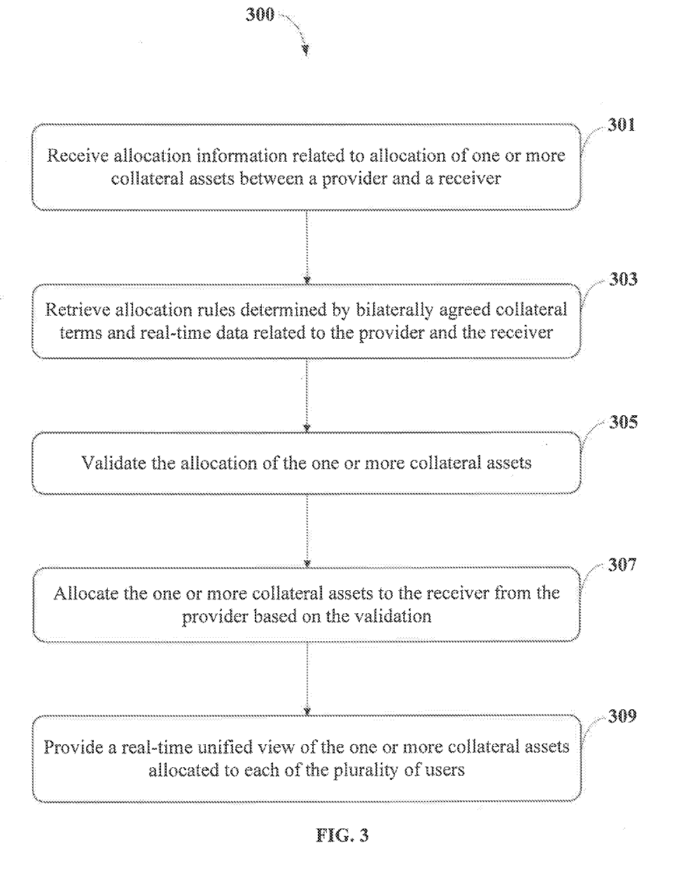

FIG. 3 shows a flowchart illustrating a method for providing a real-time unified viewing access to the plurality of users in accordance with some embodiments of the present disclosure.

As illustrated in FIG. 3, the method 300 includes one or more blocks illustrating a method for providing real-time unified viewing access to the plurality of users for monitoring collateral asset allocation using a collateral allocation system 101, for example the collateral allocation system 101 of FIG. 1. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, method 300 comprises receiving, by the collateral allocation system 101, allocation information 113 related to allocation of the one or more collateral assets between a provider 105 and a receiver 107. The allocation information 113 may be received from a manager tri-party agent 103 of the one or more collateral assets. In an embodiment, the allocation information 113 may include, without limiting to, at least one of a Required Value (RQV) of the one or more collateral assets, initial margin value and agreed margin.

At block 303, method 300 comprises retrieving, by the collateral allocation system 101, allocation rules 115 determined by bilaterally agreed collateral terms and real-time data 117 related to the provider 105 and the receiver 107 from a reference database 111 associated with the collateral allocation system 101. In an embodiment, the allocation rules 115 determined by bilaterally agreed collateral terms are the mutual agreements between the provider 105 and the receiver 107 and may include, without limiting to, one or more negotiations terms between the provider 105 and the receiver 107. In an embodiment, the real-time data 117 may include, without limiting to, information related to real-time variations in values of the one or more collateral assets of the provider 105 and dynamic changes in regulatory rules 118 that govern allocation of collaterals to the receiver 107.

At block 305, method 300 comprises validating, by the collateral allocation system 101, the allocation of the one or more collateral assets by comparing the allocation information 113, the allocation rules 115 determined by bilaterally agreed collateral terms, and the real-time data 117 with regulatory rules 118. The regulatory rules 118 are predetermined set of rules provided by the one or more collateral allocation regulators 121. In an embodiment, the regulatory rules 118 may include, without limiting to, at least one of rules for checking eligibility of the provider 105 and the receiver 107, rules for checking wrong way risks, concentration limits, credit quality steps, and difference between market values of the one or more collateral assets and a predefined collateral value.

At block 307, method 300 comprises allocating, by the collateral allocation system 101, the one or more collateral assets to the receiver 107 from the provider 105 based on the validation. In an embodiment, the validation of allocation of the one or more collateral assets may be performed by determining compliance of the allocation rules 115 determined by bilaterally agreed collateral terms with the regulatory rules 118.

At block 309, method 300 comprises providing, by the collateral allocation system 101, a real-time unified view 119 of the one or more collateral assets allocated to each of the plurality of users. In an embodiment, the plurality of users comprises the provider 105, the receiver 107, the manager tri-party agent 103, the one or more collateral allocation regulators 121 and one or more monitoring organizations 123 associated with the receiver 107 and the provider 105.

Computer System

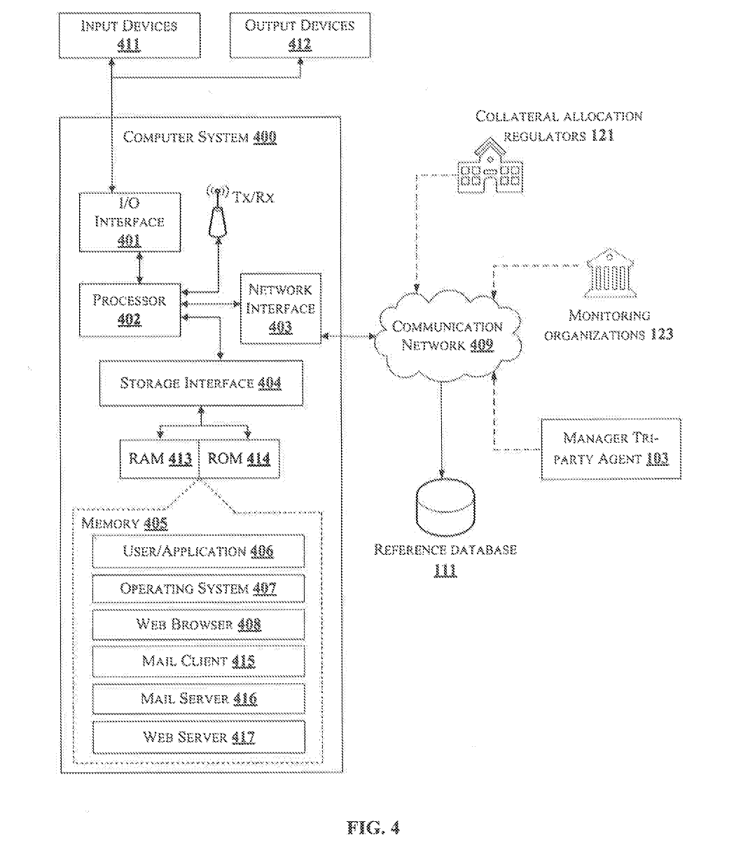

FIG. 4 illustrates a block diagram of an exemplary computer system 400 for implementing embodiments consistent with the present disclosure. In an embodiment, the computer system 400 may be the collateral allocation system 101 which is used for providing a real-time unified viewing access to the plurality of users for monitoring one or more collateral assets. The computer system 400 may include a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412). In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with a provider 105 and the receiver 107 for receiving allocation information 113 through the manager tri-party agent 103. Further, the computer system 400 may use the communication network 409 to retrieve the allocation rules 115 determined by bilaterally agreed collateral terms and the real-time data 117 from the reference database 111. Also, the communication network 409 may be used for providing the real-time unified view 119 to the plurality of users including, the provider 105, the receiver 107, the manager tri-party agent 103, the collateral allocation regulators 121, and the monitoring organizations 123.

The communication network 409 can be implemented as one of the several types of networks, such as intranet or Local Area Network (LAN) and such within the organization. The communication network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application 406, an operating system 407, web browser 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 400 may implement a web browser 408. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server 416 may be an Internet mail server such as Microsoft Exchange, or the like. The mail server 416 may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client 415. The mail client 415 may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiment of the Present Disclosure are Illustrated Herein

In an embodiment, the present disclosure discloses a method of providing real-time unified view of the collateral asset allocation process to plurality of users, using which the plurality of users can efficiently manage and monitor the collateral asset allocation.

In an embodiment, the method of the present disclosure ensures 100% compliance of collateral asset allocation process with well-defined collateral asset allocation rules through real-time checks that are digitally verified.

In an embodiment, the method of the present disclosure enhances transparency in collateral asset allocation process and management processes, thereby mitigating complexities arising out of segregation of collateral assets.

In some embodiments, the method of present disclosure uses shared record keeping and reporting while making the reference data immutable. This helps in maintaining consensus among all key participants to make the collateral asset allocation process democratic and solution strategic.

In an embodiment, the method of present disclosure helps in reduction of costs pertaining to IT infrastructure and operational expenses for the parties involved in the collateral management by eliminating need for periodic reconciliation between the parties.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Collateral allocation system |
| 103 | Manager tri-party agent |
| 105 | Provider |
| 107 | Receiver |
| 111 | Reference database |
| 113 | Allocation information |
| 115 | Allocation rules |
| 117 | Real-time data |
| 118 | Regulatory rules |
| 119 | Real-time unified view |
| 121 | Collateral allocation regulators |
| 123 | Monitoring organizations |
| 201 | I/O interface |
| 203 | Processor |
| 205 | Memory |
| 207 | Data |
| 209 | Modules |
| 213 | Other data |
| 215 | Receiving module |
| 217 | Allocation validation module |
| 219 | Collateral allocation module |
| 221 | Real-time view provider |
| 223 | Other modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory |
| 406 | User/Application |
| 407 | Operating system |
| 408 | Web browser |
| 409 | Communication network |
| 411 | Input devices |
| 412 | Output devices |
| 413 | RAM |
| 414 | ROM |
| 415 | Mail client |
| 416 | Mail server |
| 417 | Web server |

What is claimed is:

1. A method of providing real-time unified viewing access to plurality of users for monitoring collateral asset allocation, the method comprising:
receiving, by a collateral allocation system (101), allocation information (113) related to allocation of one or more collateral assets between a provider (105) and a receiver (107), from a manager tri-party agent (103) of the one or more collateral assets;
retrieving, by the collateral allocation system (101), allocation rules (115) determined by bilaterally agreed collateral terms and real-time data (117) related to the provider (105) and the receiver (107) from a reference database (111) associated with the collateral allocation system (101);
validating, by the collateral allocation system (101), the allocation of the one or more collateral assets by comparing the allocation information (113), the allocation rules (115) determined by bilaterally agreed collateral terms, and the real-time data (117) with regulatory rules (118);
allocating, by the collateral allocation system (101), the one or more collateral assets to the receiver (107) from the provider (105) based on the validation; and
providing, by the collateral allocation system (101), a real-time unified view (119) of the one or more collateral assets allocated to each of the plurality of users.

2. The method as claimed in claim 1, wherein the allocation information (113) comprises at least one of a Required Value (RQV) of the one or more collateral assets, initial margin of one or more collateral assets and agreed margin of the one or more collateral assets.

3. The method as claimed in claim 1, wherein the regulatory rules (118) are predetermined set of rules provided by one or more regulators (121) of the collateral asset allocation process.

4. The method as claimed in claim 1, wherein the regulatory rules (118) comprises at least one of rules for checking eligibility of the provider (105) and the receiver (107), rules for checking wrong way risks, concentration limits, credit quality steps, and difference between market values of the one or more collateral assets and a predefined collateral value.

5. The method as claimed in claim 1, wherein the allocation rules (115) determined by bilaterally agreed collateral terms comprise mutual agreements between the provider (105) and the receiver (107) and are periodically updated.

6. The method as claimed in claim 1, wherein validating the allocation of the one or more collateral assets comprises determining, by the collateral allocation system (101), compliance of the allocation rules (115) determined by bilaterally agreed collateral terms with the regulatory rules (118).

7. The method as claimed in claim 1, wherein validation and allocation of the one or more collateral assets to the receiver (107) from the provider (105) are implemented on a collateral allocation blockchain platform.

8. The method as claimed in claim 1, wherein the plurality of users comprises the provider (105), the receiver (107), the manager tri-party agent (103), one or more regulators (121) of the collateral asset allocation and one or more monitoring organizations (123) associated with the receiver (107) and the provider (105).

9. A collateral allocation system (101) for providing real-time unified viewing access to plurality of users for monitoring collateral asset allocation, the collateral allocation system (101) comprises:
a processor; and
a memory communicatively coupled to the processor, wherein the memory stores processor-executable instructions, which, on execution, causes the processor to:
receive allocation information (113) related to allocation of one or more collateral assets between a provider (105) and a receiver (107), from a manager tri-party agent (103) of the one or more collateral assets;
retrieve allocation rules (115) determined by bilaterally agreed collateral terms and real-time data (117) related to the provider (105) and the receiver (107) from a reference database (111) associated with the collateral allocation system (101);
validate the allocation of the one or more collateral assets by comparing the allocation information (113), the allocation rules (115) determined by bilaterally agreed collateral terms, and the real-time data (117) with regulatory rules (118);
allocate the one or more collateral assets to the receiver (107) from the provider (105) based on the validation; and
provide a real-time unified view (119) of the one or more collateral assets allocated to the plurality of users involved in the monitoring of collateral asset allocation.

10. The collateral allocation system (101) as claimed in claim 9, wherein the allocation information (113) comprises at least one of a Required Value (RQV) of the one or more collateral assets, initial margin of one or more collateral assets and agreed margin of the one or more collateral assets.

11. The collateral allocation system (101) as claimed in claim 9, wherein the regulatory rules (118) are predetermined set of rules provided by one or more regulators (121) of the collateral asset allocation process.

12. The collateral allocation system (101) as claimed in claim 9, wherein the regulatory rules (118) comprises at least one of rules for checking eligibility of the provider (105) and the receiver (107), rules for checking wrong way risks, concentration limits, credit quality steps, and difference between market values of the one or more collateral assets and collateral value.

13. The collateral allocation system (101) as claimed in claim 9, wherein the allocation rules (115) determined by bilaterally agreed collateral terms comprise mutual agreements between the provider (105) and the receiver (107) and are periodically updated by the processor.

14. The collateral allocation system (101) as claimed in claim 9, wherein the instructions cause the processor to determine compliance of the allocation rules (115) determined by bilaterally agreed collateral terms with the regulatory rules (118) to validate the allocation of the one or more collateral assets.

15. The collateral allocation system (101) as claimed in claim 9, wherein the instructions cause the processor to perform validation and allocation of the one or more collateral assets to the receiver (107) on a collateral allocation blockchain platform.

16. The collateral allocation system (101) as claimed in claim 9, wherein the plurality of users comprises the provider (105), the receiver (107), the manager tri-party agent (103), one or more regulators (121) of the collateral asset allocation and one or more monitoring organizations (123) associated with the receiver (107) and the provider (105).

17. A non-transitory computer readable medium including instructions stored thereon that when processed by a collateral allocation system (101), performs operations comprising:
receiving allocation information (113) related to allocation of one or more collateral assets between a provider (105) and a receiver (107), from a manager tri-party agent (103) of the one or more collateral assets;
retrieving allocation rules (115) determined by bilaterally agreed collateral terms and real-time data (117) related to the provider (105) and the receiver (107) from a reference database (111) associated with the collateral allocation system (101);
validating the allocation of the one or more collateral assets by comparing the allocation information (113), the allocation rules (115) determined by bilaterally agreed collateral terms, and the real-time data (117) with regulatory rules (118);
allocating the one or more collateral assets to the receiver (107) from the provider (105) based on the validation; and
providing a real-time unified view (119) of the one or more collateral assets allocated to each of the plurality of users.
